(19) United States
(12) Patent Application Publication
(10) Pub. No.: US 2024/0400154 A1
(43) Pub. Date: Dec. 5, 2024

(54) Bicycle Animal Cart Device

(71) Applicant: Aaron Haisen, Lakewood, CA (US)

(72) Inventor: Aaron Haisen, Lakewood, CA (US)

(21) Appl. No.: 18/492,259

(22) Filed: Oct. 23, 2023

Related U.S. Application Data
(60) Provisional application No. 63/505,192, filed on May 31, 2023.

(51) Int. Cl. B62K 27/00; A01K 1/02

(52) U.S. Cl. CPC B62K 27/003; A01K 1/0281

(57) ABSTRACT

A bicycle animal cart device is provided. The device is comprised of a trailer-like frame with an interior space that can be used to transport at least one animal. The frame attaches to the rear axle of a bicycle via at least one mounting arm and mounting bracket. As a result, the device can be pulled behind the bicycle while transporting an animal.

### CROSS-REFERENCE TO RELATED APPLICATION

The present application claims priority to, and the benefit of, U.S. Provisional Application No. 63/505,192, which was filed on May 31, 2023, and is incorporated herein by reference in its entirety.

### FIELD OF THE INVENTION

The present invention relates generally to the field of animal transportation devices. More specifically, the present invention relates to a bicycle animal cart device that can be attached to a bicycle and used to pull at least one animal behind the bicycle. Accordingly, the present disclosure makes specific reference thereto. Nonetheless, it is to be appreciated that aspects of the present invention are also equally applicable to other like applications, devices, and methods of manufacture.

### BACKGROUND

Individuals with dogs or other animals often embark on adventures and travel with their dogs to parks, hiking trails, and more. However, older dogs, as well as those with limited stamina or physical disabilities, may face challenges in keeping up with the physical demands of long walks or rigorous activities. Some may experience fatigue quickly, while others might deal with discomfort due to pre-existing health conditions or the wear and tear that comes with age. In such scenarios, the responsibility often falls on the pet owners to carry them, ensuring their comfort and well-being.

Carrying a dog, particularly for extended periods, might not be feasible for every pet owner. The varying sizes and weights of dogs, coupled with the physical capability of the owner, can make this task daunting and sometimes impractical. This can lead to a decrease in the frequency and duration of outdoor activities, which are vital for a dog's physical and mental stimulation.

Further, many individuals use bicycles as a mode of transportation during such outdoor adventures. Bicycling presents a unique set of challenges when it comes to transporting animals, especially those who are older or have physical limitations. Balancing on a bicycle while ensuring the safety and comfort of an animal is a task that requires skill and caution. The pet owner must navigate the terrain, control the speed, and ensure the pet is secure, all of which can be particularly challenging when the pet is not accustomed to bicycle rides or when the route is rugged. In addition, the size of some animals may not allow the animals to be transported via bicycle.

Therefore, there exists a long-felt need in the art for an animal transportation device. There also exists a long-felt need in the art for an animal transportation device that can be used to transport an animal without having to carry the animal. More specifically, there exists a long-felt need in the art for a bicycle animal cart device that can be attached to a bicycle in order to transport an animal in the device behind the bicycle.

The subject matter disclosed and claimed herein, in one embodiment thereof, comprises a bicycle animal cart device. The device is comprised of a trailer-like frame with an interior space that can be used to transport at least one animal. The frame attaches to the rear axle of a bicycle via at least one mounting arm and mounting bracket. As a result, the device can be pulled behind the bicycle while transporting an animal.

In this manner, the bicycle animal cart device of the present invention accomplishes all the foregoing objectives and provides an animal transportation device that can be used to transport an animal without having to carry the animal. More specifically, the device provides a trailer-like structure that can be attached to a bicycle in order to transport an animal in the device behind the bicycle.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bicycle animal cart device. The device is comprised of a trailer frame that attaches to a bicycle.

The frame allows a user to transport at least one animal, such as, but not limited to, a dog, within the frame while pulling the device via a bicycle, such as, but not limited to, an electric or manual bicycle.

The frame is preferably rectangular with at least one vertical frame member and at least one horizontal frame member. The frame is comprised of at least one wheel. The wheel allows the device to be easily pulled behind a bicycle. In one embodiment, animals can be lifted into and out of the frame, wherein the frame may have four immovable walls. In a different embodiment, the frame is comprised of at least one ramp that forms an entire (or a portion of) at least one side of the frame.

To attach the device to a bicycle, the device is comprised of at least one attachment arm comprised of at least one mounting bracket with at least one opening. As a result, the rear axle of the bicycle can be placed through the opening and the bracket can be secured to the axle and bicycle via at least one fastener. Then, at least one attachment member of the arm can be attached to the bracket via placing at least one fastener, such as, but not limited to, a pin of any type, through at least one opening of the attachment member and at least one opening of the mounting bracket. The pin further allows the arm to rotate/move relative to the position of the bicycle.

The present invention is also comprised of a method of using the device. First, a device is provided comprised of a frame comprised of at least one wheel, an interior space, at least one attachment arm, and at least one mounting bracket. Then, a rear axle of a bicycle can be placed through an opening in the mounting bracket and the axle can be secured via at least one fastener. Then, at least one attachment member of the attachment arm can be secured to the mounting bracket via placing at least one fastener through openings of the mounting bracket and member. Next, at least one safety strap can be attached to the bicycle via at least one fastener of the strap. Then, a user can place an animal within the interior space and pedal the bicycle to transport the animal using the device.

In another method of using the device, a device is provided comprised of a frame comprised of at least one wheel, an interior space, at least one attachment arm, a ramp, and at least one mounting bracket. Then, a rear axle of a bicycle can be placed through an opening in the mounting bracket and the axle can be secured via at least one fastener. Then, at least one attachment member of the attachment arm can be secured to the mounting bracket via placing at least one fastener through openings of the mounting bracket and member. Next, at least one safety strap can be attached to the bicycle via at least one fastener of the strap. Then, a user can lower the ramp to allow an animal to walk up the ramp and into the interior space. Next, a user can secure the ramp in a vertical position to a portion of the frame via at least one locking member. Finally, a user can pedal the bicycle to transport the animal using the device.

Accordingly, the bicycle animal cart device of the present invention is particularly advantageous as it provides an animal transportation device that can be used to transport an animal without having to carry the animal. More specifically, the device provides a trailer-like structure that can be attached to a bicycle in order to transport an animal in the device behind the bicycle. In this manner, the bicycle animal cart device provides a solution to transport animals using a bicycle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a bicycle animal cart device of the present invention while attached to a bicycle in accordance with the disclosed architecture;

FIG. 2 illustrates a rear view of one potential embodiment of a bicycle animal cart device of the present invention in accordance with the disclosed architecture;

FIG. 3 illustrates an enhanced view of an attachment arm of one potential embodiment of a bicycle animal cart device of the present invention while attached to a bicycle in accordance with the disclosed architecture;

FIG. 4 illustrates a flowchart of a method of using one potential embodiment of a bicycle animal cart device of the present invention in accordance with the disclosed architecture; and

FIG. 5 illustrates a flowchart of a method of using one potential embodiment of a bicycle animal cart device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an animal transportation device. There also exists a long-felt need in the art for an animal transportation device that can be used to transport an animal without having to carry the animal. More specifically, there exists a long-felt need in the art for a bicycle animal cart device that can be attached to a bicycle in order to transport an animal in the device behind the bicycle.

The present invention, in one exemplary embodiment, is comprised of a bicycle animal cart device comprised of a trailer frame that attaches to a bicycle. The frame allows a user to transport at least one animal, such as, but not limited to, a dog, within the frame while pulling the device via a bicycle, such as, but not limited to, an electric or manual bicycle.

The frame is preferably rectangular with at least one vertical frame member and at least one horizontal frame member. The frame is comprised of at least one wheel that allows the device to be easily pulled behind a bicycle. In one embodiment, animals can be lifted into and out of the frame, wherein the frame may have four immovable walls. In a different embodiment, the frame is comprised of at least one ramp that forms an entire (or a portion of) at least one side of the frame.

To attach the device to a bicycle, the device is comprised of at least one attachment arm. The arm is comprised of at least one mounting bracket with at least one opening. As a result, the rear axle of the bicycle can be placed through the opening and the bracket can be secured to the axle and bicycle via at least one fastener. Then, at least one attachment member of the arm can be attached to the bracket via placing at least one fastener, such as, but not limited to, a pin of any type, through at least one opening of the attachment member and at least one opening of the mounting bracket. The pin further allows the arm to rotate/move relative to the position of the bicycle.

The present invention is also comprised of a method of using the device. First, a device is provided comprised of a frame comprised of at least one wheel, an interior space, at least one attachment arm, and at least one mounting bracket. Then, a rear axle of a bicycle can be placed through an opening in the mounting bracket and the axle can be secured via at least one fastener. Then, at least one attachment member of the attachment arm can be secured to the mounting bracket via placing at least one fastener through openings of the mounting bracket and member. Next, at least one safety strap can be attached to the bicycle via at least one fastener of the strap. Then, a user can place an animal within the interior space and pedal the bicycle to transport the animal using the device.

In another method of using the device, a device is provided comprised of a frame comprised of at least one wheel, an interior space, at least one attachment arm, a ramp, and at least one mounting bracket. Then, a rear axle of a bicycle can be placed through an opening in the mounting bracket and the axle can be secured via at least one fastener. Then, at least one attachment member of the attachment arm can be secured to the mounting bracket via placing at least one fastener through openings of the mounting bracket and member. Next, at least one safety strap can be attached to the bicycle via at least one fastener of the strap. Then, a user can lower the ramp to allow an animal to walk up the ramp and into the interior space. Next, a user can secure the ramp in a vertical position to a portion of the frame via at least one locking member. Finally, a user can pedal the bicycle to transport the animal using the device.

Accordingly, the bicycle animal cart device of the present invention is particularly advantageous as it provides an animal transportation device that can be used to transport an animal without having to carry the animal. More specifically, the device provides a trailer-like structure that can be attached to a bicycle in order to transport an animal in the device behind the bicycle. In this manner, the bicycle animal cart device provides a solution to transport animals using a bicycle.

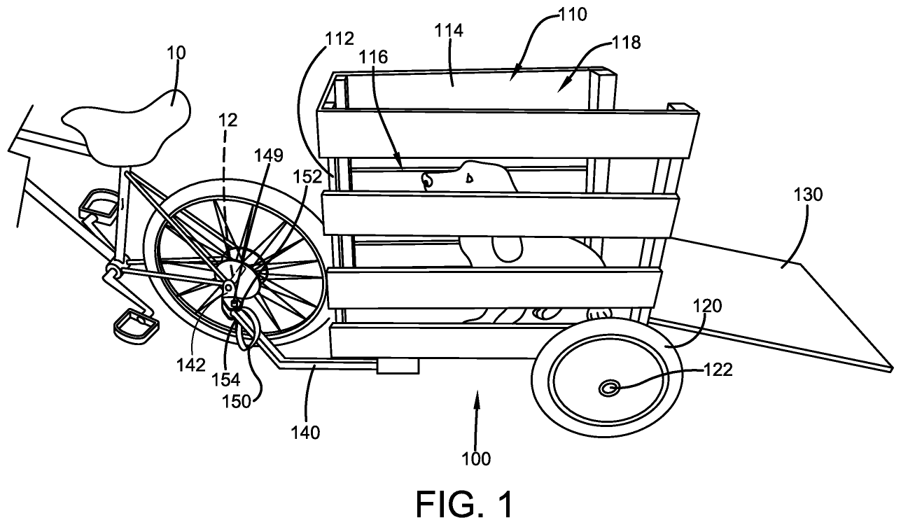

Referring initially to the drawings, FIG. 1 illustrates a perspective view of one potential embodiment of a bicycle animal cart device 100 of the present invention while attached to a bicycle 10 in accordance with the disclosed architecture. The device 100 is comprised of trailer frame 110 that attaches to a bicycle 10. The frame 110 allows a user to transport at least one animal, such as, but not limited to, a dog, within the frame 110 while pulling the device 100 via a bicycle 10, such as, but not limited to, an electric or manual bicycle.

The frame 110 may be any shape, size, and configuration to transport any animal. The frame 110 may be made from any material such as, but not limited to, wood, metal, plastic, etc. The frame 110 is preferably rectangular with at least one vertical frame member 112 and at least one horizontal frame member 114. In one embodiment, there may be at least one opening 116 between two horizontal frame members 114 (and/or vertical frame members 112) of the frame 110 in order to allow an animal within the device 100 to look outwards from the frame 110 when in the interior space 118 of the frame 110.

The frame 110 is comprised of at least one wheel 120. In the preferred embodiment, the frame 110 is comprised of at least one axle 122, wherein the axle 122 is comprised of at least one wheel 120 on each side of the axle 122. The wheel 120 allows the device 100 to be easily pulled behind a bicycle 10. The wheel 120 may be any type of wheel known in the art.

In one embodiment, animals can be lifted into and out of the frame 110, wherein the frame 110 may have four immovable walls. In a different embodiment, the frame 110 is comprised of at least one ramp 130 that forms an entire (or a portion of) at least one side of the frame 110. The ramp 130 may attach to the frame 110 via at least one hinge 132 of any type known in the art.

After an animal walks up the ramp 130 and into the interior space 118 of the frame 110. the ramp 130 can be rotated upwards at 90 degrees about the hinge 132 and locked into a vertical position to at least one frame member 112, 114 via at least one locking member 134 such as, but not limited to, a latch, a key lock, etc. This prevents the ramp 130 from inadvertently moving/falling while the device 100 is in motion with animals inside the interior space 118.

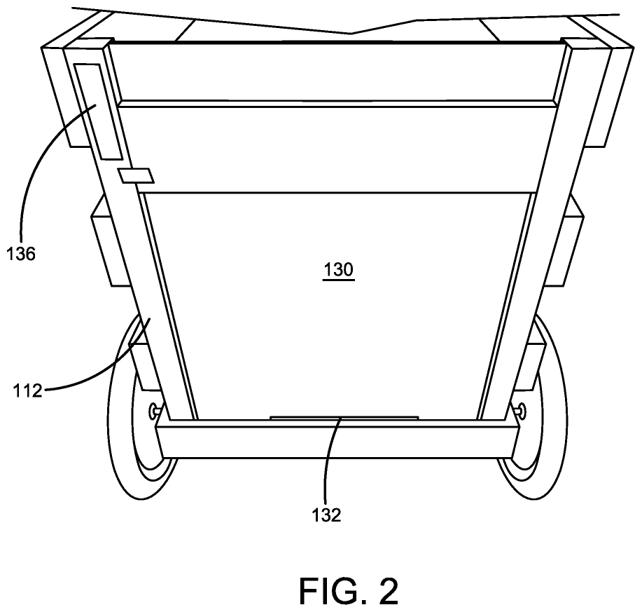

In one embodiment, the frame 110 may be comprised of at least one reflector 136, as seen in FIG. 2. The reflector 136 may be any color and size. The reflector 136 may be made from any reflective material in order to ensure the device 100 remains visible at night or in other low-light conditions.

To attach the device 100 to a bicycle 10, the device 110 is comprised of at least one attachment arm 140. The arm 140 is comprised of at least one mounting bracket 142 with at least one opening 144. As a result, the rear axle 12 of the bicycle 10 can be placed through the opening 144 and the bracket 142 can be secured to the axle 12 and bicycle 10 via at least one fastener 146 such as, but not limited to, a nut and washer assembly. In one embodiment, the device 100 has two arms 140, with each arm 140 on one side of the rear wheel of the bicycle 10 and wherein each arm 140 attaches to the rear axle 12.

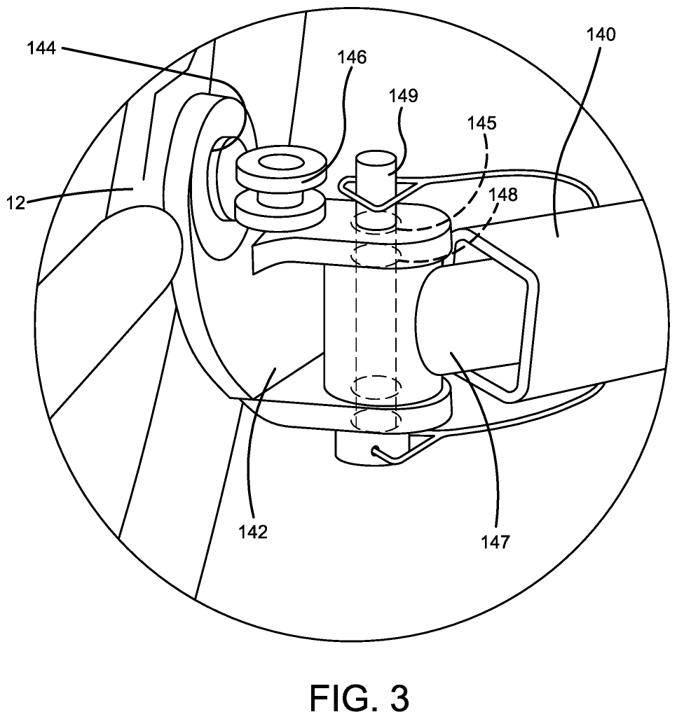

Then, at least one attachment member 147 of the arm 140 can be attached to the bracket 142 via placing at least one fastener 149, such as, but not limited to, a pin of any type, through at least one opening 148 of the attachment member 147 and at least one opening 145 of the mounting bracket 142, as seen in FIG. 3. The pin 149 further allows the arm 140 to rotate/move relative to the position of the bicycle 10.

The arm 140 may also be comprised of at least one strap 150. The strap 150 acts as a failsafe in the event that the arm 140 becomes unfastened from the bicycle 10 while moving. The strap 150 is comprised of at least one fastener 152 such as, but not limited to, a clip or a clamp that can be used to attach the strap 150 to any portion of the bicycle 10. The strap 150 may also have a second fastener 154 of the same type as the first fastener 152 which attaches the strap 150 to the arm 140. In one embodiment, the strap 150 is fixedly attached to the arm 140.

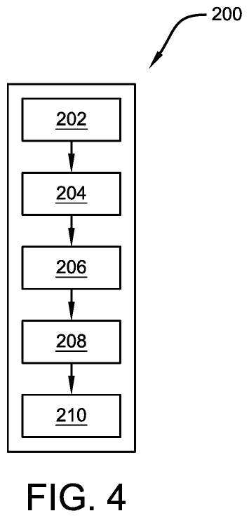

The present invention is also comprised of a method of using 200 the device 100, as seen in FIG. 4. First, a device 100 is provided comprised of a frame 110 comprised of at least one wheel 120 and an interior space 118, at least one attachment arm 140, and at least one mounting bracket 142 [Step 202]. Then, a rear axle 12 of a bicycle 10 can be placed through an opening 144 in the mounting bracket 142 and the axle 12 can be secured via at least one fastener 146 [Step 207]. Then, at least one attachment member 147 of the attachment arm 140 can be secured to the mounting bracket 142 via placing at least one fastener 149 through openings 145, 148 of the mounting bracket 142, and member 147 [Step 206]. Next, at least one safety strap 150 can be attached to the bicycle 10 via at least one fastener 152 of the strap 150 [Step 208]. Then, a user can place an animal within the interior space 118 and pedal the bicycle 10 to transport the animal using the device 100 [Step 210].

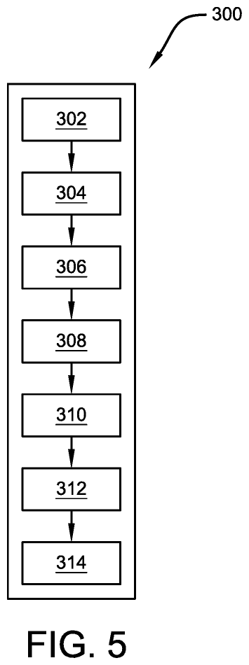

In another method of using 300 the device 100, as seen in FIG. 5, a device 100 is provided comprised of a frame 110 comprised of at least one wheel 120 and an interior space 118.

at least one attachment arm 140, a ramp 130, and at least one mounting bracket 142 [Step 302]. Then, a rear axle 12 of a bicycle 10 can be placed through an opening 144 in the mounting bracket 142 and the axle 12 can be secured via at least one fastener 146 [Step 304]. Then, at least one attachment member 147 of the attachment arm 140 can be secured to the mounting bracket 142 via placing at least one fastener 149 through openings 145, 148 of the mounting bracket 142, and member 147 [Step 306]. Next, at least one safety strap 150 can be attached to the bicycle 10 via at least one fastener 152 of the strap 150 [Step 308]. Then, a user can lower the ramp 130 to allow an animal to walk up the ramp 130 and into the interior space 118 [Step 310]. Next, a user can secure the ramp 130 in a vertical position to a portion of the frame 110 via at least one locking member 134 [Step 312]. Finally, a user can pedal the bicycle 10 to transport the animal using the device 100 [Step 314].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bicycle animal cart device” and “device” are interchangeable and refer to the bicycle animal cart device 100 of the present invention.

Notwithstanding the foregoing, the bicycle animal cart device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bicycle animal cart device 100 as shown in the FIGS. are for illustrative purposes only, and that many other sizes and shapes of the bicycle animal cart device 100 are well within the scope of the present disclosure. Although the dimensions of the bicycle animal cart device 100 are important design parameters for user convenience, the bicycle animal cart device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bicycle animal cart device comprising:
a frame;
a wheel attached to the frame;
an attachment arm attached to the frame, the attachment arm comprised of an attachment member;
a mounting bracket; and
a fastener that attaches the mounting bracket to the attachment member.

2. The bicycle animal cart device of claim 1, wherein the fastener is comprised of a pin.

3. The bicycle animal cart device of claim 1, wherein the mounting bracket is comprised of a first opening and a second opening.

4. The bicycle animal cart device of claim 1, wherein the attachment member is comprised of a third opening.

5. The bicycle animal cart device of claim 1, wherein the frame is comprised of a fourth opening.

6. The bicycle animal cart device of claim 1, wherein the frame is comprised of a vertical frame member.

7. The bicycle animal cart device of claim 1, wherein the frame is comprised of a horizontal frame member.

8. A bicycle animal cart device comprising:
a frame;
a ramp attached to the frame;
a wheel attached to the frame;
an attachment arm attached to the frame, the attachment arm comprised of an attachment member;
a mounting bracket; and
a fastener that attaches the mounting bracket to the attachment member.

9. The bicycle animal cart device of claim 8 further comprised of a locking member that secures the ramp to the frame.

10. The bicycle animal cart device of claim 8, wherein the frame is comprised of a reflector.

11. The bicycle animal cart device of claim 8 further comprised of a strap.

12. The bicycle animal cart device of claim 11, wherein the strap is comprised of a strap fastener.

13. The bicycle animal cart device of claim 12, wherein the strap fastener is comprised of a clip.

14. The bicycle animal cart device of claim 8, wherein the ramp attaches to the frame via a hinge.

15. A method of using a bicycle animal cart device, the method comprising the following steps:
providing a bicycle animal cart device comprised of a frame comprised of a wheel and an interior space, an attachment arm, and a mounting bracket;
placing a rear axle of a bicycle through a first opening of the mounting bracket and securing the mounting bracket via a first fastener;
securing an attachment member of the attachment arm to the mounting bracket via a second fastener; and
placing an animal into the interior space; and
pedaling the bicycle to transport the animal within the bicycle animal cart device.

16. The method of using a bicycle animal cart device of claim 15, wherein the second fastener is comprised of a pin.

17. The method of using a bicycle animal cart device of claim 15, wherein the frame is comprised of a ramp.

18. The method of using a bicycle animal cart device of claim 17 further comprised of a step of lowering the ramp.

19. The method of using a bicycle animal cart device of claim 18 further comprised of a step of raising the ramp.

20. The method of using a bicycle animal cart device of claim 19 further comprised of a step of securing the ramp to frame via a locking member.
